(19) United States
(12) Patent Application Publication
(10) Pub. No.: US 2004/0174341 A1
(43) Pub. Date: Sep. 9, 2004

(54) Typing aid for a computer

(76) Inventor: Daniel B. Gershuni, Zichron Yaakov (IL)

Correspondence Address: STEINBERG & RASKIN, P.C., 1140 AVENUE OF THE AMERICAS, 15th FLOOR, NEW YORK, NY, 10036-5803, US

(21) Appl. No.: 10/705,126

(22) Filed: Nov. 10, 2003

Related U.S. Application Data
(63) Continuation-in-part of application No. 09/887,255, filed on Jun. 25, 2001, now abandoned.
(60) Provisional application No. 60/268,707, filed on Feb. 15, 2001.

(51) Int. Cl. G09G 5/00

(52) U.S. Cl. 345/168

(57) ABSTRACT

A typing aid including a keyboard and an auxiliary or integrated display screen deployed in close proximity to or within the keyboard, designed to assist the non-touch typist to enter text data into a computing device with a minimum of or no head and neck movements between keyboard and display screen. Also provided is a method of entering text data into a computing device using the typing aid and an arrangement for allowing the auxiliary display screen to follow the current cursor position for document editing.

### CROSS-REFERENCE TO RELATED APPLICATIONS

This application is a continuation-in-part of U.S. patent application Ser. No. 09/887,255 filed Jun. 25, 2001 which claims priority under 35 U.S.C. §119 (e) of U.S. provisional patent application Ser. No. 60/268,707, filed Feb. 15, 2001.

### FIELD OF THE INVENTION

The present invention relates to the field of data input devices and, more particularly but not exclusively, to a keyboard with an associated display.

### BACKGROUND OF THE INVENTION

Today, the dominant tool of choice for many home and office tasks that include composing documents, e-mailing, web browsing and data entry into spreadsheets or databases is the personal computer (PC), both stationary desktop models and portable laptop models. The typical PC used to perform these tasks comprises an input device consisting of a keyboard and an output device consisting of a monitor with a display screen.

The user inputs data to a desktop PC by typing at a keyboard that typically sits in front of and slightly below the level of the display screen. This ergonomic configuration has existed since the earliest times of computing with large mainframe computer systems. The users of such mainframes sat at terminals composed of monitors and keyboards remote from the mainframe itself. This terminal model has become the de facto standard for inputting and outputting with the modern PC.

Other typing/composing tools, functionally more limited in scope than the modern PC, such as the typewriter and the word processor, addressed the input/output issue in different ways. The earliest typewriter consisted simply of a machine with a set of keys which activated a mechanical printing mechanism. Later typewriters had keys which activated an electronically driven printer. Improvements to the later typewriters included a small character display which allowed the user to review the typing before committing the text to print. U.S. Pat. No. 4,323,315 assigned to Ing. C. Olivetti & C., S.p.A., which produces Olivetti typewriters, discloses a typewriter with a small integral display that allows a user to view the last data entered. Thereafter, the IBM Wheelwriter 5000 added a small monitor to the typewriter allowing a user to review a larger amount of typing, and even allow copy and paste functionality to the typing process. This external monitor was deployed on an arm positioning the monitor a short distance above the keyboard. The next development was to incorporate the typewriter function of document production into a computer by typing at the keyboard and displaying the typed text on the display screen. Word processing capability, using the power of the computer's processor, followed immediately thereafter. The present state of the art includes numerous word processing programs capable of assisting typists in every way imaginable to produce complex documents quickly and effortlessly on a desktop or laptop PC.

However, one aspect of document production has become problematic following the incorporation of the PC into the document production process. When typing on a keyboard and displaying the typed text on a remote display screen, it is necessary for a typist to divert her eyes from the keyboard to the display in order to review the typed text. This presents no problem for the accomplished touch typist who can scan the display while continuing to type. However, the less capable typist must look at the keyboard while typing and is thus unable to continue typing while reviewing the previously typed text. Accordingly, she is required to stop typing, look at the display and look back to the keyboard in order to edit the text or to resume typing. Typing studies have shown that low level typists type in short bursts, usually between one and four words and then pause to review and correct the typing. This frequent and ongoing need to shift the eyes, including moving the head and neck, is inefficient and time consuming, resulting in reduced productivity. For the less than expert typist, this requirement is a cause of slowness, frequent mistakes and often frustration.

Moreover, this repeated activity is physically demanding on the cervical vertebral column and has become recognized as a cause of fatigue and repetitive stress injury of the administrative workforce.

### OBJECTS AND SUMMARY OF THE INVENTION

It is thus an object of the present invention to solve the above problems. There is thus provided a way to integrate the input function of the keyboard with the output function of the display screen in such a manner that a typist is not required to move her head and neck when transferring between typing and reviewing text.

According to an aspect of the present invention there is provided a keyboard with associated display. One of the advantages of having a display, preferably a diminutive of the main computer display, associated with the keyboard is to assist the non-touch typist to enter text data via the keyboard which she is able to review with a minimum of head and neck movements.

Accordingly, it is an object of the present invention to provide a typing aid that places a display screen within the same field of view as an associated keyboard thereby to allow a typist to view both the typing keys and the typed text without substantially moving the head and neck.

It is a further object of the present invention to provide a typing aid that visually integrates the input and output interfaces of a computing device to aid in the editing of data stored in the memory of the computing device.

According to one aspect of the present invention, there is provided a typing aid which includes a keyboard and a current graphical data display for assisting with user data input to a computing device. The typing aid comprises functionality for interacting with the computing device to display data associated with a current data input position on the current graphical data display. The current data input position includes newly generated data input via the keyboard and data stored in a memory of the computing device. The keyboard and the current graphical data display are located together in a single user field of view thereby enabling a user to simultaneously see the keyboard and the data associated with a current data input position.

According to another aspect of the present invention, there is provided a typing aid consisting of a computing device capable of generating data which comprises a computer having a monitor, a keyboard connected thereto and a current graphical data display, the computing device comprising functionality for displaying data associated with a current data input position on the current graphical data display. The keyboard and the current graphical data display are located together in a single user field of view thereby enabling a user to simultaneously see the keyboard and the data associated with a current data input position.

Another embodiment of a typing aid arrangement for assisting with user data input in accordance with the invention comprises a processor embodying software, a keyboard coupled to the processor, a monitor coupled to the processor and including a primary display screen, and a current graphical data display arranged proximate the keyboard such that visualization of the keyboard encompasses visualization of the current graphical data display, i.e., the keyboard and current graphical data display can be viewed simultaneously without a user having to remove their view from the keyboard. The current graphical data display is preferably separate from the primary display screen of the monitor, i.e., is not a portion thereof.

In accordance with the invention, the processor includes means for receiving input from the keyboard, means for processing the input to form processed input including modifications resulting from application of an input processing program to the input from the keyboard (e.g., a word processing program) and means for interacting with the monitor and the current graphical data display to cause the same processed input to be displayed on both the display screen and the current graphical data display. The processor can be programmed to cause the current graphical data to display only a portion of the processed input being displayed on the display screen and/or display data associated with a current data input position including newly generated data input via the keyboard and data stored in a memory of the processor.

An important aspect of the invention is that the processor tracks changes made to the processed input in the active application which are reflected/displayed/presented on the primary display screen are also reflected/displayed/presented on the current graphical data display. In this manner, if the processed input on the primary display screen is changed, e.g., via a mouse, the same changes will appear on the current graphical data display.

The current graphical data display may be arranged to display only a single line of processed input. To enable it to receive processed input, derived at least in part from the keyboard input, the current graphical data display is arranged to receive input commands to display graphics only from the processor and not directly from the keyboard. The processor may be arranged to cause the current graphical data display to display entry fields dependent on software being run by input from the keyboard, only graphics within a predetermined proximity to a cursor on the display screen and/or display graphics accessed by input from the keyboard and stored in memory associated with the processor.

According to another aspect of the present invention, there is provided a method of assisting with user data input to a computing device comprising the steps of

a. interrogating an operating system of the computing device regarding a location of a current data input position;

b. identifying, from the interrogation, data associated with the current data input position which includes at least one of newly generated data input via a keyboard and data stored in a memory of the computing device;

c. sending the identified data to an output associated with the keyboard; and

d. displaying the identified data on a current graphical data display which is located together with the keyboard in a single user field of view such as to allow simultaneous viewing by a user of the current graphical data display and the keyboard.

In some embodiments of the invention, the typing aid further comprises functionality for directly displaying, on the current graphical data display, newly generated data input via the keyboard thereby enabling a user to simultaneously see the keyboard and the newly generated data input via the keyboard.

According to features in the described preferred embodiments the typing aid further comprises functionality for editing the data associated with a current data position.

In some embodiments of the invention, the current graphical data display may be integral to the keyboard.

The current graphical data display may be, but is not required to be, removably attachable or attached to the keyboard.

The current graphical data display may optionally be an LCD screen.

The current graphical data display may be powered from the computing device.

In some embodiments of the invention, the current graphical data display is powered by its own independent power supply.

In some embodiments of the invention, the data associated with the current data input position is at least part of a text document or, alternatively, any program having text data input.

In various embodiments of the invention, the current graphical data display may be capable of showing a single line of text, the current data input position may be indicated by the presence thereat of a cursor, the data associated with the current data input position may comprise the text preceding and/or following the cursor, the cursor may be at the beginning, middle or end of a text document, and the cursor may be capable of moving around within a text document thereby changing the display on the current graphical data display.

The cursor may be capable of moving between different text documents thereby changing the display on the current graphical data display and/or between different software applications thereby changing the display on the current graphical data display.

The present invention successfully addresses the shortcomings of the presently known configurations by providing a typing aid designed to assist the non-touch typist to enter text data via a keyboard with reduced head and neck movements.

The term “cursor”, as used in the present description with claims, includes a current data input position however indicated or even if not indicated to a user.

### BRIEF DESCRIPTION OF THE DRAWINGS

With specific reference now to the drawings in detail, it is stressed that the particulars shown are by way of example and for the purposes of illustrative discussion of the preferred embodiment of the present invention only, and are presented to provide what is believed to be the most useful and readily understood description of the principles and conceptual aspects of the invention. In this regard, no attempt is made to show structural details of the invention in more detail than is necessary for a fundamental understanding of the invention. The description taken with the drawings makes apparent to those skilled in the art how the several forms of the invention may be embodied in practice.

### IN THE DRAWINGS:

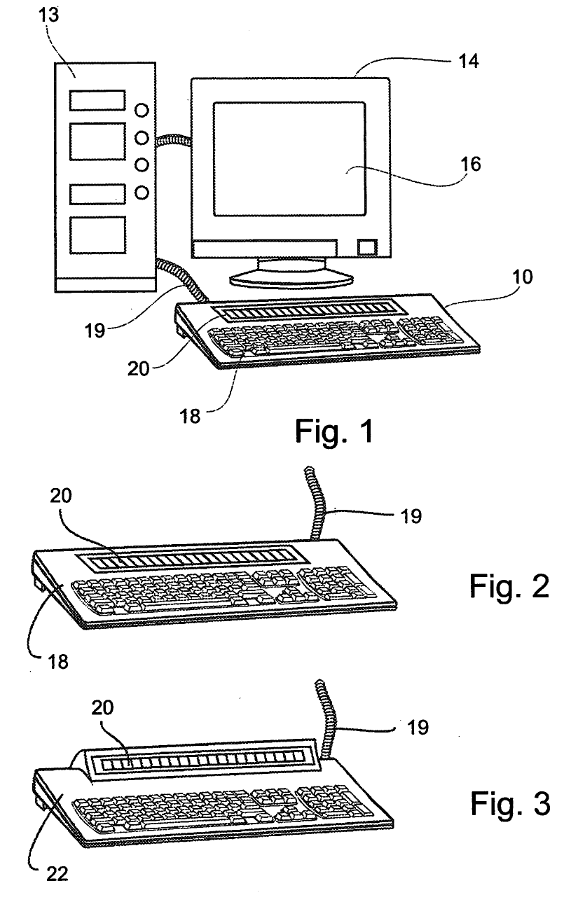

FIG. 1 is a schematic illustration of a typing aid constructed in accordance with one embodiment of the present invention deployed with respect to a computing device.

FIG. 2 is a schematic illustration of a hardwired keyboard with an integral current graphical data display in accordance with the embodiment of the typing aid of FIG. 1.

FIG. 3 is a schematic illustration of a hardwired keyboard with a current graphical data display removably attached thereto in accordance with the embodiment of the typing aid of FIG. 1.

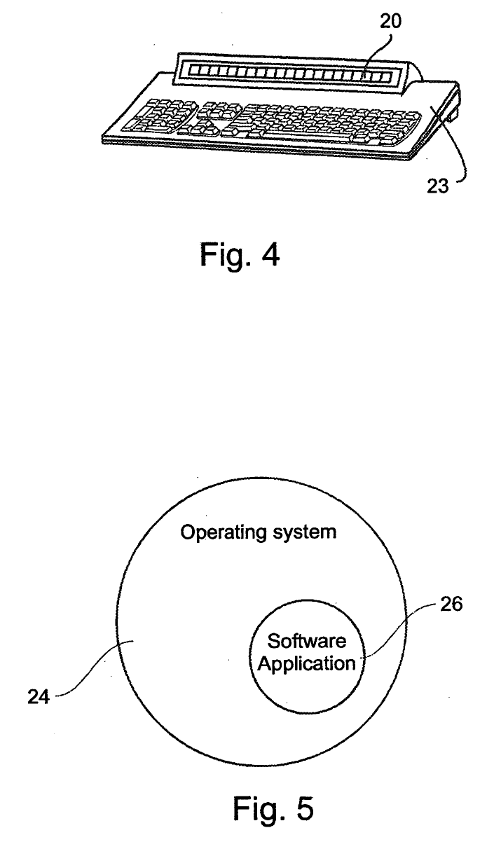

FIG. 4 is a schematic illustration of a wireless keyboard with a current graphical data display removably attached thereto in accordance with another embodiment of the typing aid in accordance with the invention.

FIG. 5 is a black box diagram of the software configuration in accordance with a preferred embodiment of the typing aid in accordance with the invention.

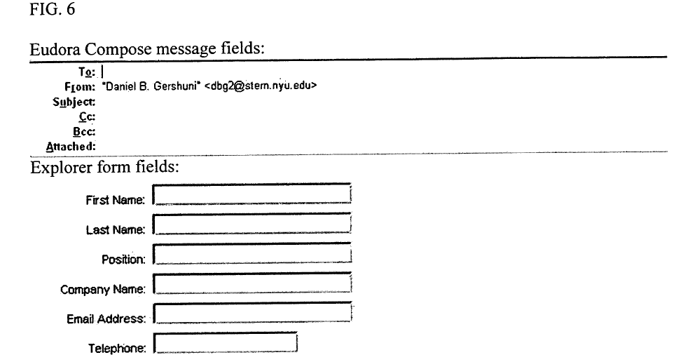

FIG. 6 is a sample screen of an e-mail program (Eudora) and an Internet access program (Explorer) whose use would be simplified using the typing aid in accordance with the invention.

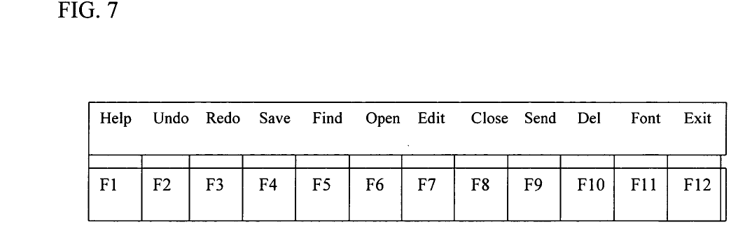

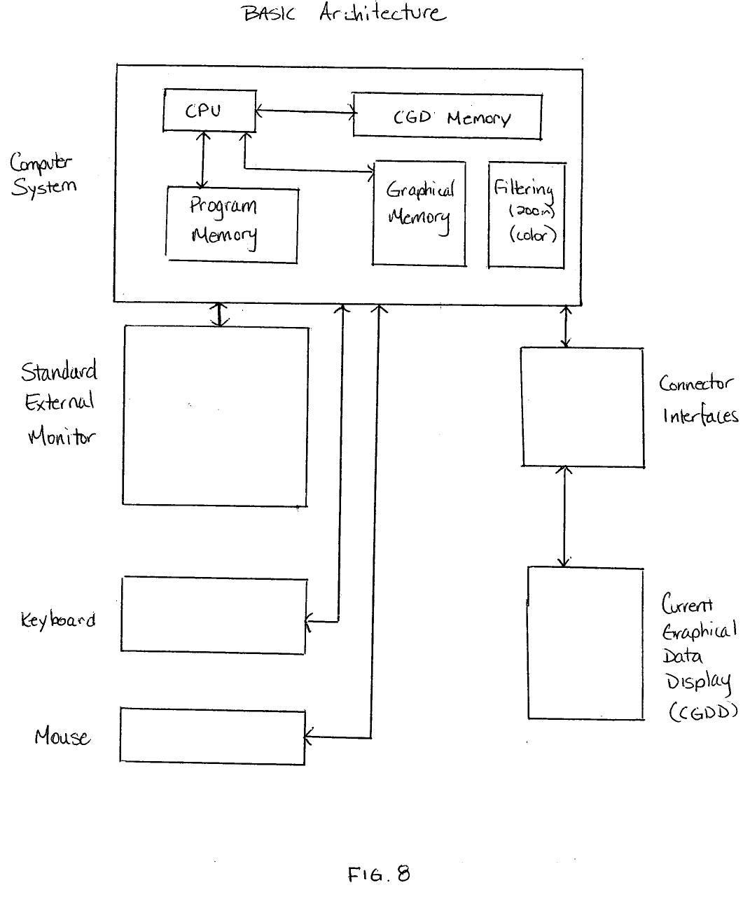

FIG. 7 is a display of assignment of functions to function keys on a keyboard.

FIG. 8 is a schematic showing the arrangement of components in a typing aid in accordance with the invention.

### DETAILED DESCRIPTION OF THE PREFERRED EMBODIMENTS

Before explaining at least one embodiment of the invention in detail, it is to be understood that the invention is not limited in this application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

The principles and operation of a typing aid according to the present invention may be better understood with reference to the drawings and accompanying descriptions.

Reference is now made to FIG. 1 which shows a typing aid constructed in accordance with one embodiment of the present invention which is referred to hereinbelow as typing aid 10. Typing aid 10 is deployed with respect to a computing device which consists of a computer 13, a monitor 14 bearing display screen 16 and other standard computing peripherals. The skilled reader will be aware of variations of this standard arrangement such as computers not having a separate tower and display, for example, the typical “Mac” configuration, and computers which are portable and self contained, such as laptops. It will be appreciated that embodiments of typing aid 10 may preferably be constructed so as to be compatible with all such configurations.

Typing aid 10 preferably comprises a keyboard 18 associated with current graphical data display 20, and may be considered as part of the computing device. Typing aid 10 is an aid to typists, but is preferably not part of a word processing program or system installed within computer 13. Rather, it is a separate application, consisting of hardware and software, that is usable by a user who types at computer 13, which may or may not support a word processing program, to facilitate the entry of text data into an application. It is useful with respect to computer 13 irrespective of the existence of a word processing program or of the application in use. Typing aid 10 is preferably designed and configured to be compatible with any data entry environment that requires the entry of text data via a keyboard which produces a visual display.

The current graphical data display (CGDD), also optionally referred to as the current data screen, is capable of displaying the exact contents of the display screen 16, such as graphics including icons and pictures, and is not limited to the display of character data. Typing aid 10 is not an electric typewriter although its appearance is similar to electronic typewriters which have data displays integrated therein. In fact, the typing aid 10 in accordance with the invention differs from an electric typewriter in that prior art electric typewriters with data displays are programmed to display exactly what is being typed. By contrast, in view of the unique coupling of the secondary display 20 to the software of the CPU 13 (described below), the secondary display 20 is programmed to display processed input data which is identical to the processed input data being displayed on the display screen 16. That is, the CPU 13 contains software which processes the input data (the keyboard character stream) to create processed input data, e.g., word processing software such as Word, WordPerfect, which is then displayed on the display screen 16 and the secondary display 20. There is no difference between the characters and/or graphics being displayed on the display screen 16 and those being displayed on the secondary display 20. Thus, the secondary display 20 is not a character display as in prior art electric typewriters that pass user input from the keyboard directly from the keyboard to an LCD character display or other data display.

Current graphical data display 20 graphically displays data associated with the current typing position in very close proximity to keyboard 18 on which such data is being entered. This proximal arrangement of input interface and output interface permits a typist to simultaneously see keyboard 18 and the data being entered as a result of her strokes upon keyboard 18. It is easily appreciated that such an arrangement reduces the need for shifting the gaze from keyboard 18 to display screen 16.

The field of typing instruction provides guidance with respect to the common practices of typists. A less skilled typist will exhibit certain common behaviors.

1. She will keep her head pointed down and squarely at the keyboard while she types.

2. She will type “bytes” or bursts of information ranging from one to four words at a time.

3. She will raise her head up to the monitor in order to find the blinking cursor to review the most recently typed data.

4. If a mistake is found, she will lower her head to the keyboard and locate either the backspace key or the arrow keys.

5. Keeping her finger on the necessary key (either backspace or arrow), she will raise her head back up to the monitor and tap the key until either the text has been deleted or the cursor is in the correct position.

6. She will, thereafter, lower her head back down to the keyboard and type the necessary correction.

7. Having made the modification, she will raise her head back up to the monitor, review the text and, if problem-free, lower her head again and recommence typing.

This seven step process repeats itself every few words throughout the duration of typing.

This process, is grossly inefficient, time consuming and unenjoyable. It causes slowness of data entry and requires that a substantial amount of time be devoted to error correction. Moreover, it is physically demanding on the typist's neck and eyes, requiring repeated flexion and extension of the cervical structure.

Accordingly, typing aid 10 is properly described primarily as an aid for typing efficiency, and secondarily as a device which provides orthopaedic and ophthalmologic benefits. The use of typing aid 10 reduces head and neck movement in the course of typing, thereby reducing or preventing cervical muscle fatigue and repetitive stress injury to neck ligaments and tendons. Additional benefits include reducing or preventing other orthopaedic conditions associated with typing, including Carpal Tunnel Syndrome and Repetitive Stress Injury of the elbow, forearm, wrist and fingers. Moreover, typing aid 10 provides ophthalmologic benefit by reducing the likelihood of eye strain. Eye strain is often caused by continuous and repetitive shifting of focus from an object closer to an object farther from the viewer. Such shifting of focus requires the ciliary eye muscles to repeatedly contract and relax to change the focal length of the lens of the eye, resulting in eye muscle fatigue, commonly known as eye stain.

Reference is now made to FIG. 2 which shows current graphical data display 20 as an integral element of keyboard 18, which is a conventionally hardwired keyboard which communicates with computer 13 via hardwire 19. Current graphical data display 20 is so named because it is preferably limited to graphically displaying the data associated with the current typing position. In other words, it displays a predetermined quantity of the most recently typed characters or the characters associated with the current position of the cursor.

It will be appreciated that current graphical data display 20 may be incorporated into any size, shape or type of keyboard, including ergonomic keyboards, sectional keyboards and even virtual keyboards, in which case current graphical data display 20 may preferably appear virtually on a display screen. Data screen 20 may be incorporated into wireless keyboards, thus increasing their versatility by allowing a user of such a keyboard to function at a greater distance from the monitor upon which the data is displayed. Examples of types of keyboards into which current graphical data display 20 may be incorporated include, inter alia, Qwerty, Dvorak, alphabetical, diagonally alphabetical, and random.

Current graphical data display 20 may be configured in many different ways. It may be fixed on the surface plane of the keyboard either in a flat or raised attitude, or it may be movable, tiltable, recessed, protruding, or in any other way adjustable to meet the requirements of users. Moreover, current graphical data display 20 may, with some size limitations, be configured to display more or less lines of typing comprising more or less characters per line. It will be appreciated that various embodiments will have different data quantity capacities. Moreover, a buffer memory may optionally be associated with current graphical data display 20.

Reference is now made to FIG. 3 which shows current graphical data display 20 removably attached to a preexisting keyboard 22, which is a conventionally hardwired keyboard which communicates with computer 13 via hardwire 19. A further embodiment of typing aid 10 provides for current graphical data display 20 to be configured as a separate apparatus which may be placed in close proximity to or upon keyboard 22 in order to facilitate the simultaneous viewing of keyboard 22 and the most recently typed data. Such a configuration allows typing aid 10 to serve as an aftermarket add-on to computing devices currently in use with an existing keyboard. Current graphical data display 20 is preferably attachable by means of mounting brackets, Velcro or adhesive attachment means or may be designed with a shape that allows it to mount upon or engage keyboard 22. It will be appreciated that different embodiments of current graphical data display 20 may be designed and configured for specifically identified keyboards.

Both in its stand alone (retrofitted) embodiment and integrated embodiment, the current graphical data display (CDGG) 20 and associated software based in the computer or CPU 13 become a new platform. With continuous wireless communication with the CPU 13, the current graphical data display 20 can become a fully-functional wireless output device. According to the user requests, a stream of information could be sent to the current graphical data display 20 including, but not limited to real time stock ticker quotes, new emails, news headlines, weather information, sports scores, reminder messages etc. or caller ID sent from a separate caller ID unit (similar to how certain cordless phones also display caller ID info). The wirelessly connected current graphical data display 20 becomes an extension of the CPU 13 allowing continuous mobile connectivity. In the integrated embodiment, the wireless connectivity to the CPU 13 is bi-directional allowing both messages from the CPU 13 to the current graphical data display 20, and user-input via the keyboard 18,22 back to the CPU 13. Similarly, if the current graphical data display 20 is a touch screen, or has some hardware controls (like scrolling up and down), then the connectivity must be bi-directional, otherwise it could be uni-directional CPU>CGDD.

The CGDD 20 optionally takes on some PDA-like functionality, however as opposed to a PDA that has processing, and significant on-board memory and logic capabilities, the CGDD 20 serves as a somewhat “dumb” terminal—that receives all its information pre-processed from the CPU 13. The CGDD 20 can also be “synced” (synchronized) with the CPU 13, so you could download a recipe from the Internet, sync/send/download the info to the CGDD 20 and then scroll through the recipe in the comfort of your kitchen.

It is appreciated that current graphical data display 20 may be configured for any known keyboard. FIG. 4 depicts current graphical data display 20 in a further embodiment engaged upon keyboard 23 which is a wireless keyboard which communicates with computer 13 using wireless communication technology. Accordingly, current graphical data display 20 may be configured as required in order to communicate with a range of host keyboards so that characters keyed in thereon will be displayed on current graphical data display 20.

In one embodiment, the CGDD 20 becomes the primary output device, not the secondary output device. In the wireless embodiment, the keyboard, with the attached screen, has the ability to serve as a stand alone unit, that allows data input, as well as output. This can be utilized in instances like a casual computing environment where the user sits on his or her couch with a wireless keyboard at a distance from the main monitor, and cannot see the small-font output on the main monitor. Another particularly advantageous scenario would be using interactive TV with a wireless keyboard at a distance where it is not possible to see the typed input. Thus, the CDGG can be used in combination with keyboard devices used for navigating interactive TV, or any other TV-based, keyboard controlled devices.

In the most common PC-environment, the user will utilize both the mini-display (e.g., the current graphical data display) on the keyboard and the main display. However, in certain wireless embodiments, the CGDD can take on a more central role and become the primary display device. For instance, if a user wants to lie in bed and type a short e-mail. The user could type the entire e-mail using the keyboard with mini-display alone for input and review. Wirelessly, the information would be communicated with the working application, and the send command could be activated from the keyboard, thus an entire e-mail could be typed, reviewed and sent at a distance from the computer and main display. Similarly, incoming emails could be read in such a manner, allowing the user greater flexibility and mobility.

The method of this communication will vary according to different embodiments of typing aid 10. According to embodiments in which the current graphical data display 20 is integral to keyboard 18, communication may take place inside keyboard 18 with keyboard 18 internally wired to send the appropriate character stream to current graphical data display 20. However, a more preferred embodiment would be to configure the CPU 13, keyboard 18 and current graphical data display 20 such that the keyboard 18 and current graphical data display 20 communicate via computer 13, either by hardwire or by wireless communication, and keyboard-input data is sent from the keyboard 18 to the computer 13 and processed graphical data is sent from the computer 13 to the current graphical data display 20 (as well as to the display screen 16). In such an embodiment, communication between keyboard 18 and computer 13 will preferably be bi-directional such that data may pass from keyboard 18 to computer 13 and from computer 13 to data screen 20.

According to embodiments in which current graphical data display 20 is removably attachable to keyboard 22, current graphical data display 20 may be capable of communicating directly with computer 13. Such communication will preferably be uni-directional from keyboard 22 to computer 13 and also uni-directional from computer 13 to current graphical data display 20. Such communication may take place in a number of different manners, including, but not limited to, the following:

1. A direct hard wire connection from keyboard 22 to current graphical data display 20.

2. A wireless connection from keyboard 22 to current graphical data display 20 based on wireless technologies such as IR (Infrared) or RF (radio frequency), or any other wireless communication means for example using the Blue Tooth protocol.

3. The existing hard wire connection from keyboard 22 to computer 13 with a splitter emanating from the hard wire connecting computer 13 to monitor 14 and connecting to current graphical data display 20.

4. The existing hard wire connection from keyboard 22 to computer 13 and a direct hard wire connection from computer 13, emanating from a communication port thereof (i.e. Serial, Parallel, SCSSI, Ethernet, Coax, PS/2, firewire, USB or IR) to current graphical data display 20.

5. The existing hard wire connection from keyboard 22 to computer 13 and a wireless connection from computer 13 to current graphical data display 20.

According to embodiments in which current graphical data display 20 is removably attachable to keyboard 23, communication may take place via wireless connection from keyboard 23 to current graphical data display 20 based on wireless technologies such as IR (Infrared) or RF (radio frequency), or any other wireless communication means, for example using the Blue Tooth protocol.

In summary, communication between the components of typing aid 10, and further between typing aid 10 and a computing device with which it may be employed is subject to various implementations and may, in future embodiments, utilize newly developed communications technology.

The source of power supplied to current graphical data display 20 will vary according to the different embodiments, from being powered by its host computing device to being powered by its own independent power supply. In the case of the integral configuration, current graphical data display 20's power source will be the same as the keyboard's power source. In the case of the removably attachable configuration the power could be supplied either by the host computing device or by current graphical data display 20's self contained power supply. If the removably attachable configuration employs wireless communication between current graphical data display 20 and the computing device, then current graphical data display 20 will preferably have its own power source, since it cannot rely upon a hard wire connection with the computing device to convey power therefrom.

Current graphical data display 20 preferably employs any display technology currently available. In this respect, the display may be an LCD, LED or Organic LED display or any other display technology that may be known to the skilled person. The display on current graphical data display 20 may preferably be variable in many different respects such as color, size, contrast, etc. according to the technology available and the desires of the typist. It is appreciated that current graphical data display 20 may be configured to have a versatile display capability, comprising many components designed to provide maximum visibility from which a typist may select in order to facilitate typing productivity, such as colored text, variable brightness, bolded characters, adjustable size fonts, etc.

It is the object of the invention to offer the most useful and user friendly ergonomic configuration. Therefore, a range of current display alternatives are preferably provided, ranging from plain, unformatted alphanumerical data to formatted and colorized alphanumeric text resembling the text which appears on the display of external monitor 14.

According to one embodiment, current graphical data display 20 displays text in a user selected size, font, and formatting, independent of the size, font and formatting of the software application in use. According to this embodiment the display will have its own choice of fonts and settings from which the user may select. The embodiment requires limited logic and memory capabilities.

According to another embodiment, the current graphical data display 20 displays, to the extent possible, WYSIWYG (What You See Is What You Get) based on the display on external monitor 14. The objective is to provide the greatest consistency between what the user sees on monitor 14 and what is seen on current graphical data display 20. To accomplish this, computer 13 sends to current graphical data display 20 both ASCII code containing the text and formatting code containing font, color, size, effects etc. Accordingly, this embodiment requires more involved logic and memory capabilities to properly display the WYSIWYG formatted text.

Thus, as shown in FIG. 8, the keyboard 18 is not directly connected to the current graphical data display 20 but rather, the keyboard 18 is connected to the CPU 13 which is turn is connected to and controls the current graphical data display 20 (via connector interfaces), as well as the display screen 16 of monitor 14. The CPU 13 includes usual components thereof such as program memory, graphical memory, filters, etc.

It is important to note that the current graphical data display 20 acts as a duplicate display to the display screen 16 in that it displays a small section of the material shown in the display screen 16. The material displayed on the current graphical data display 20 has the same features as the text displayed on the display screen 16. In this regard, a significant advantage of the invention is obtained in that it is known that word processing programs often include commands to enable shortcuts in the typing of text, such as the Autocorrect function and automatic date function in Word. Thus, when typing in Word, if the Autocorrect function is set to correct “ssytem” to “system”, then when the user types “ssytem”, the word “system” will appear on the display screen 16 and on the current graphical data display 20. This results from the fact that the current graphical data display 20 is controlled by the CPU 13 and receives data and graphics to display from the CPU 13 and not directly from the keyboard 16. Rather, the current graphical data display 20 receives input data from the keyboard 16 only indirectly as the input data first passes through the CPU 13 and is processed thereby (and is acted upon by the Autocorrect function). In an electric typewriter including a display screen which shows what is being typed, the word “ssytem” would appear. In view of this difference, the invention provides a substantial improvement over other previous typing aids.

An additional aspect of functionality of the invention is a user-defined level of magnification. If the user has no problems of vision, and wishes to maximize the number of characters fitting on the display, and keep the consistency of the display screen 16 of the main monitor 14 to CGDD 20, then the user can choose a magnification level of ×1 (or 100% or 1:1). Thus, if the characters appear 10 mm tall on the display screen 16 of the main monitor 14 in the current application, then they will appear the identical size on the CGDD 20. However, if the user is visually impaired (or not) and would prefer a magnification level of ×2 (or more), then the data and characters would appear twice the size on the CGDD 20 than on the display screen 16 of the main monitor 14. One may suggest that visually impaired users should magnify the entire contents of the main screen to improve readability, however this is very demanding on screen “real estate” or space. By magnifying only the area around the cursor, and passing this to a secondary screen, you are conserving space on the main monitor. Also, for visually or cognitively impaired users, the act of locating the blinking cursor amongst the mêlée of data on the main screen, can be a daunting task in its own right, which the invention aims to solve. For this purpose, current graphical data display 20 preferably relies on the logic and memory capabilities of computer 13. This may be accomplished by installing a splitter connection so that data are sent to external monitor 14 from the serial port of computer 13 and in parallel from serial port to current graphical data display 20. Such a configuration utilizes the processor, video card functionality and serial port of computer 13, simply passing the information to current graphical data display 20 at the time the data are being sent to monitor 14. It can also be accomplished by sending the data from computer 13 to current graphical data display 20 through an alternate port, such as the USB port, with the necessary logic and memory capabilities built in to current graphical data display 20.

Typing aid 10 is not only useful for creating new documents, typing aid 10 is particularly versatile in its capacity to be applied to the document production capabilities of computer 13. In a typical configuration, computer 13 preferably supports a word processing application which permits text data stored in its memory to be brought to display screen 16 for editing. Typing aid 10 may be used to assist in this purpose.

Reference is now made to FIG. 5 which shows a software application 26 which is supported by operating system 24 of computer 13. According to a preferred embodiment, typing aid 10 is supported by software installed in computer 13 which provides it with data selection capabilities allowing it to find and identify the data associated with a current data input position on screen 16. Such data is customarily located adjacent to the curser irrespective of where in a document the cursor is located. The cursor may be at the beginning, at the end or within a document. The cursor may move from one document to another document with software application 26 retaining the capability to find and identify the data associated therewith. Moreover, the cursor may move from one program to another, with software application 26 retaining the capability to find and identify the data associated therewith. Software application 26 allows typing aid 10 to select, perhaps according to an expressed user preference, the data associated with a current data input position and to display the data on current graphical data display 20. Such data may comprise file text preceding the cursor, following the cursor or on both sides of the cursor. Thus, references to a cursor include all of the above-described modes of indicating a current data position.

Software application 26 also provides typing aid 10 with the capability to select and display on current graphical data display 20 data from other applications supported by computer 13, including newly received or downloaded data and data stored in the memory of computer 13. Such other applications may preferably comprise any programs which include the production or use of text data. In some programs, the data associated with a current data input position is not related to a cursor or is not located in proximity to a cursor. Rather, the data associated with a current data input position may be data associated with an active field displayed for data entry.

Moreover, the data associated with a current data input position need not be entered via a keyboard, but may be entered by a mouse or other method of data entry unrelated to keyboard use. It is to be appreciated that software application 26 is capable of identifying the current data position, however it may be designated, and displaying data associated therewith however it may be entered, on current graphical data display 20.

Software application 26 preferably accesses operating system 24 to obtain from the operating system, the text from around the current data position, which it is then able to send to current graphical data display 20. The display functionality of operating system 24 is utilized and thus software application 26 works through the API or operating system programmers interface, with any application properly supported by operating system 24. Software application 26 preferably comprises a device driver application which loads on startup of operating system 24 and may also comprise a program which displays field and format data in the current graphical data display. In this case, the field name or designation will also be displayed in current graphical data display 20.

Software application 26 identifies active/focus application, and then cursor position, and computes a rectangular window of correct size based on the following characteristics:

1. Size of physical display window (CGDD size)

2. Characteristic of zoom level (magnification level)

3. Output type (data representation type of CGDD) sent to CGDD as input.

When Software application 26 is running, every time there is a cursor event, which causes change in current cursor location, (including but not limited to: alphanumeric key pressed, control key (pgup, tab, enter, space), mouse click etc.) software application 26 computes graphical rectangle, appropriately sends graphical data over network, via drivers to appropriate display device (CGDD).

Software application 26 optionally includes a filtering system, for converting graphical data associated with current cursor position to appropriate data representation form to be used as input for the CGDD 20, based on the following characteristics/parameters:

1. Color depth of target display device (CGDD)

2. Pixels, dimensions of CGDD

3. Zoom/magnification level

4. CGDD update characteristics dictating when new data is sent to CGDD, when to refresh CGDD content.

5. Data representation format that CGDD accepts as input.

The graphical data output of software application 26 is sent via appropriate data channel either wirelessly or wired to the CGDD 20. Since the data representation outputted to CGDD 20 has already been appropriately processed to be compatible and suitable for the input of the CGDD 20, a minimum of logic and processing capacity is required on-board the CGDD 20. The processed graphical data is sent over the network via software drivers and connectors to the appropriate display device. The CGDD 20 receives the input from software application 26 (or CPU 13), places the data in memory, then video driver takes data in memory and displays it on screen.

When a cursor event occurs, software application 26 has two alternative methods/approaches for sending new graphical data to CGDD for display:

1. A full buffer transfer of graphical data of rectangle associated with current cursor position, or

2. A differential update based on an efficient differential mechanism. This approach is best for low-bandwidth configurations, where minimizing data quantity is preferable. With this method, the existing data sitting in CGDD's 20 on-board memory would shift appropriately, and new data sent from CPU 13 (or software application 26) would be received and appropriately modify display content.

Since one goal of the present invention is to maximize usability and provide maximum user benefit and utility, a system is described which controls display attributes and behavior. Two important design aims of the present invention are:

1. Have data appear in center-aligned fashion on the CGDD 20 so that the typist can look consistently to the center of the CGDD 20 to see the results of her typing.

2. All necessary, aiding informational cues, like those found in the form of field headers, appear in full on the CGDD 20.

Thus, software application 26 would preferably include a means/method for graphically displaying data associated with current cursor position in a center-aligned fashion on the CGDD 20, regardless of the alignment in the current application. Additionally, software application 26 has a means for identifying field coordinates. Referring to FIG. 6, in Eudora's fields, the field coordinates would be from 1 space after the To:, where the cursor (|) is located. That marks the left border of the field. So, software application has the ability to understand the left side border location (and right side border location for languages that are right to left). In other words, the field border is defined as the first position of the cursor per row.

Once left/right extreme coordinate is identified, then a predetermined number of pixels or graphical data proceeding that coordinate is captured as well. So, in the Explorer form in FIG. 6, the application will identify the location of the left most input field border (graphically represented by a vertical line), and will capture a certain amount of graphical data (either a number of centimeters, or number of pixels) to the left, preceding that border (i.e., First Name: or Company Name:)

The above-described method/algorithm/rules are application independent, that work across all applications.

Moreover, in embodiments in which a multi-language program is employed, program 26 is able to interrogate operating system 24 as to the currently enabled language, thereby to display the ASCII code accordingly.

In some embodiments, it is conceivable that the system is no longer based on display receiving and displaying ASCII code, rather pixel-based graphical data. Language mode is still important for the purposes of identifying whether the data field's text direction is right-to-left, or left-to-right, so as to display field label information proceeding in a direction from either the left or right of the cursor.

Preferably, the software application, once loaded on startup of the operating system operates in the background constantly searching for the current data position in any program, including web browser programs, and upon finding the data position, sends the appropriate text to current graphical data display 20. In program interfaces where in addition to the cursor there is present a field name like “user name”, “password” “file name,”, “subject”, “address,” “location,”, etc., the typing aid will display the field name in addition to the text entered by the curser. Moreover, current graphical data display 20 may preferably display such data in one or more of a number of ways, such as scrolling, flashing, fading in and out, etc., as may be appropriate to the data or helpful to the user. In further utilization of this capability, further embodiments or typing aid 10 will preferably find many varied uses for current graphical data display 20 and this description contemplates such a varied and versatile capacity for use.

This invention is not limited to simply aiding in text entry of documents in word processing programs, but has much wider application. The invention supports and aids in data/text entry in a variety of application and typing scenarios. Examples include, but are not limited to: spreadsheets, databases, Web forms, and email. Special emphasis is placed on providing the user all the necessary cues to give him/her contextual awareness. Specifically cues, like field headers and labels can be displayed on the CGDD 20 in order to cue the user to the active field. For instance, in composing an email in Eudora or Outlook, field labels like to:, cc:, subject etc. will appear on the CGDD 20. Similarly, field labels found in filling in a web form including first name:, last name:, address, credit card number, will also be displayed on the CGDD 20. All of these possibilities result from the fact that the current graphical data display 20 is controlled by the CPU 13, and not directly by the keyboard.

Software application 26 is preferably stored in an installable format on any or the many storage devices currently in use such as a CD or a 1.44 MB capacity disc or on any that may be devised in the future that possess the required capacity or in a downloadable format as could be downloaded from a communications network.

Software application 26 is preferably installed at the time of the installation of typing aid 10. Software application 26 is supportable by operating systems such as Windows, OS2, Unix, Linux, or Mac and therefore has wide applicability within currently operating computer configurations. It will be appreciated that in further embodiments typing aid 10 may preferably be a “plug & play” device, wherein operating system 24 has the driver information and other supporting software built-in, thus obviating the need for user installation of a software application.

Touch screen functionality may be applied in the invention to allow users to click, or touch icons, allowing direct manipulation. This would increase the overall functionality of the keyboard and allow greater use of the keyboard at a distance from the CPU and main display.

Referring now to FIG. 7, another aspect of functionality, significantly different than its primary function of providing feedback to the non-touch typist is a dynamic, application-sensitive, function key label. In most applications, the function keys (F1-F12) of the keyboard 18 are used as short cut, key equivalents, to a point and click mouse operation. For instance, in many applications, hitting F1 is a shortcut for help. However in Word, F5 is the key equivalent for “Find & Replace”, whereas in Excel F5 is the “Go To” function. Clearly it is a challenge to remember what function keys serves what purpose in all the different applications.

As such, an advantageous use of the current graphical data display 20 arranged just above or below the row of function keys on the keyboard 18 would be to display the labels for each function key. As the program being used changes, the labels would be refreshed to be applicable to the in-focus/active application. Therefore, even touch typists who use, but haven't memorized all the functions keys, in all the different programs, would find benefit in the utilizing the CGDD 20. The CPU 13 could be programmed to toggling [toggle] between different modes of operation of the current graphical data display 20—i.e., 1. Displaying graphical data around cursor, and 2. Displaying function key labels 3. Stock Ticker 4. Weather/Traffic information 5. Sport Scores

More specifically, to accomplish this functionality, software application 26 would include means for querying active application for key equivalents of application-specific function keys. When a query is responded to with appropriate information, information is processed accordingly in software application 26 to convert/adapt data to the proper format and data type to be sent to the CGDD 20. In summary, the close proximity of current graphical data display 20 and its related keyboard addresses and solves most, if not all, of the disabilities faced by non-touch typists, such as:

1. Slowness caused by the time associated with uncertain typing because the absence of immediate feedback;

2. Inefficiency of error correction caused by the distance between keyboard and monitor. Because a user unknowingly commits an error and continues typing. The error is often several characters or words back in the latest addition to the text.

3. The time consuming nature of having to find the relevant, recently edited line of text indicated by the blinking cursor.

4. The ongoing physical demand of cocking the head up and down between keyboard and monitor.

Therefore, the particular advantages of including typing aid 10 into the process of data entry on a personal computer directly address the above listed problems, as follows:

1. By viewing the results of her typing as she types without oscillating her head, the typist receives many of the benefits that the touch-typist experiences, such as simultaneous ongoing review including, for multi-lingual keyboards, ongoing indication of the language mode enabled, This will ease the burden/nuisance experienced by users of bi-lingual operating systems and programs. For example, users of Hebrew enables Windows with Hebrew/English Word will frequently confuse which language mode has been set and type for some time only to see gibberish thereafter.

2. Mistakes can be easily found and corrected immediately after they occur because they are immediately apparent on current graphical data display 20. This reduces the burden of repeated, extensive backspacing and backtracking the cursor to find and correct errors on a monitor containing a substantial amount of data.

It is appreciated that certain features of the invention, which are, for clarity described in the context of separate embodiments, may also be provided in combination in a single embodiment. Conversely, various features of the invention which are, for brevity, described in the context of a single embodiment may also be provided separately or in any suitable subcombination.

It will be appreciated by persons skilled in the art that the present invention is not limited to that which has been particularly shown and described hereinabove. Rather, the scope of the present invention is defined by the appended claims and includes both combinations and subcombinations of the various features described hereinabove as well as variations and modifications thereof which would occur to persons skilled in the art upon reading the foregoing description. Accordingly, it is intended to embrace all such alternatives, modifications and variations that fall within the spirit and broad scope of the appended claims.

I claim:

1. A typing aid arrangement for assisting with user data input, comprising:
a processor embodying software;
a keyboard coupled to said processor;
a monitor coupled to said processor and including a primary display screen; and
a current graphical data display arranged proximate [to]said keyboard such that visualization of said keyboard encompasses visualization of said current graphical data display, said current graphical data display being separate from said primary display screen of said monitor;
said processor including means for receiving input from said keyboard, means for processing the input to form processed input including modifications resulting from application of an input processing program to the input from said keyboard and means for interacting with said monitor and said current graphical data display to cause the same processed input to be displayed on both said display screen and said current graphical data display.

2. The arrangement of claim 1, wherein said processor is arranged to cause said current graphical data to display only a portion of the processed input being displayed on said display screen.

3. The arrangement of claim 1, wherein said processor is arranged to cause said current graphical data to display data associated with a current data input position including newly generated data input via said keyboard and data stored in a memory of said processor.

4. The arrangement of claim 1, wherein said current graphical data display is structured and arranged such that said current graphical data display is couplable to said keyboard as a retrofitted part whereby said current graphical data display is employed as an after market add on to said keyboard.

5. The arrangement of claim 1, wherein said current graphical data display is removably attachable to said keyboard.

6. The arrangement of claim 1, wherein said processor enables changes to the processed input being displayed on said display screen, optionally via a mouse, and causes said current graphical data display to alter the processed input displayed thereon in accordance with changes made to the processed input being displayed on said display screen.

7. The arrangement of claim 1, wherein said current graphical data display is arranged to display only a single line of processed input.

8. The arrangement of claim 1, wherein said current graphical data display is integral with said keyboard.

9. The arrangement of claim 1, wherein said current graphical data display is arranged above function keys of said keyboard and is controlled by said processor to display functions assigned to said function keys dependent on software being run by input from said keyboard.

10. The arrangement of claim 1, wherein said current graphical data display is arranged to receive input commands to display graphics only from said processor and not directly from said keyboard.

11. The arrangement of claim 1, wherein said processor is arranged to cause said current graphical data display to display entry fields dependent on software being run by input from said keyboard.

12. The arrangement of claim 1, wherein said processor is arranged to cause said current graphical data display to display only graphics within a predetermined proximity to a cursor on said display screen.

13. The arrangement of claim 1, wherein said processor is arranged to cause said current graphical data display to display graphics accessed by input from said keyboard and stored in memory associated with said processor.

14. The arrangement of claim 1, wherein said receiving means, said processing means and said interacting means comprise software.

15. A typing aid for assisting with user data input to a computer having a processor embodying software and a monitor coupled to the processor and including a primary display screen; and, comprising:
a keyboard adapted to be coupled to the processor;
a current graphical data display arranged proximate said keyboard such that visualization of said keyboard encompasses visualization of said current graphical data display, said current graphical data display being separate from the primary display screen of the monitor;
receiving means for receiving input from said keyboard;
processing means for processing the input from said keyboard to form processed input including modifications resulting from application of an input processing program to the input from said keyboard; and
interacting means for interacting with the monitor and said current graphical data display to cause the same processed input to be displayed on both the display screen and said current graphical data display.

16. The typing aid of claim 15, wherein said interacting means are arranged to display on said current graphical data display only a portion of the processed input being displayed on the display screen.

17. The typing aid of claim 15, wherein said interacting means are arranged to display on said current graphical data display data associated with a current data input position including newly generated data input via said keyboard and data stored in a memory of the processor.

18. The typing aid of claim 15, wherein said current graphical data display is structured and arranged such that said current graphical data display is couplable to said keyboard as a retrofitted part whereby said current graphical data display is employed as an after market add on to said keyboard.

19. The typing aid of claim 15, wherein said current graphical data display is removably attachable to said keyboard.

20. The typing aid of claim 15, wherein the processor enables changes to the processed input being displayed on said display screen, optionally via a mouse, and causes said current graphical data display to alter the processed input displayed thereon in accordance with changes made to the processed input being displayed on said display screen.

21. The typing aid of claim 15, wherein said current graphical data display is arranged to display only a single line of processed input.

22. The typing aid of claim 15, wherein said current graphical data display is integral with said keyboard.

23. The typing aid of claim 15, wherein said current graphical data display is arranged above function keys of said keyboard and is adapted to be controlled by the processor to display functions assigned to said function keys dependent on software being run by input from said keyboard.

24. The typing aid of claim 15, wherein said current graphical data display is arranged to receive input commands to display graphics only from the processor and not directly from said keyboard.

25. The typing aid of claim 15, wherein said interacting means are arranged to cause said current graphical data display to display entry fields dependent on software being run by input from said keyboard.

26. The typing aid of claim 15, wherein said interacting means are arranged to cause said current graphical data display to display only graphics within a predetermined proximity to a cursor on said display screen.

27. The typing aid of claim 15, wherein said interacting means are arranged to cause said current graphical data display display graphics accessed by input from said keyboard and stored in memory associated with the processor.

28. The typing aid of claim 15, wherein said receiving means, said processing means and said interacting means comprise software.
